(19) United States
(12) Patent Application Publication
(10) Pub. No.: US 2025/0006932 A1
(43) Pub. Date: Jan. 2, 2025

(54) SECONDARY BATTERY

(71) Applicant: MURATA MANUFACTURING CO., LTD., Kyoto (JP)

(72) Inventor: Yasushi MORI, Kyoto (JP)

(21) Appl. No.: 18/734,365

(22) Filed: Jun. 5, 2024

(30) Foreign Application Priority Data
Jun. 28, 2023 (JP) 2023-106207

(51) Int. Cl. H01M 4/62; H01M 4/02; H01M 10/0525; H01M 10/0568; H01M 10/0569

(52) U.S. Cl. CPC H01M 4/62; H01M 10/0525; H01M 10/0568; H01M 10/0569; H01M 2004/027

(57) ABSTRACT

A secondary battery is provided and including a positive electrode; a negative electrode; and an electrolyte, wherein the secondary battery is operable to be subject to a low-temperature cycle, followed by high-temperature storage or a room-temperature cycle, and on a surface of the negative electrode, a fluorine atom concentration is higher than an oxygen atom concentration based on X-ray photoelectron spectroscopy after the high-temperature storage or the room-temperature cycle, compared to after the low-temperature cycle.

### CROSS REFERENCE TO RELATED APPLICATIONS

The present application claims priority to Japanese patent application no. 2023-106207, filed on Jun. 28, 2023, the entire contents of which are incorporated herein by reference.

### BACKGROUND

The present disclosure relates to a secondary battery.

Conventionally, a secondary battery that can be repeatedly charged and discharged has been used for various applications. For example, secondary batteries are used as power supplies for electronic devices such as smart phones and notebook computers.

A secondary battery has a structure in which an electrode assembly including a positive electrode, a negative electrode, and a separator disposed between the positive electrode and the negative electrode, and an electrolyte are housed in an exterior body. Each electrode includes a current collector, and an electrode material layer provided on at least one main surface of the current collector. Specifically, the positive electrode includes a positive electrode current collector, and a positive electrode material layer provided on at least one main surface of the positive electrode current collector. The negative electrode includes a negative electrode current collector, and a negative electrode material layer provided on at least one main surface of the negative electrode current collector. The secondary battery is, for example, a lithium secondary battery.

### SUMMARY

The present disclosure relates to a secondary battery.

It has been known that the lithium secondary battery may accept fewer lithium ions into the negative electrode material layer of the negative electrode when the lithium secondary battery is repeatedly charged and discharged at a relatively low temperature (for example, −20 to 10° C.), that is, when a low-temperature cycle is performed.

In this regard, when carbonates are used as the solvent of the electrolyte and LiPF₆ (lithium hexafluorophosphate) is used as the solute of the electrolyte, lithium ions that have not been accepted into the negative electrode material layer during charging may be bonded with carbonate groups to form Li₂CO₃ (lithium carbonate).

In addition, when Li₂CO₃ and LiPF₆ coexist in the battery, an exothermic reaction may occur at a high temperature (about 100° C. to about 180° C.), and the battery may have a lower thermal stability. In particular, when the battery reaches a temperature zone causing the exothermic reaction during an overload test or the like after a low-temperature cycle, there may be a risk that the battery explodes, and the battery may have a lower thermal stability.

The present disclosure has been devised in view of such circumstances. The present disclosure relates to providing a secondary battery capable of securing thermal stability after a low-temperature cycle according to an embodiment.

The present disclosure provides, in an embodiment, a secondary battery including: a positive electrode; a negative electrode; and an electrolyte, wherein
the secondary battery has been subjected to a low-temperature cycle, followed by high-temperature storage or a room-temperature cycle, and
on a surface of the negative electrode, a fluorine atom concentration is higher than an oxygen atom concentration based on X-ray photoelectron spectroscopy after the high-temperature storage or the room-temperature cycle, compared to after the low-temperature cycle.

The secondary battery according to an embodiment of the present disclosure is capable of securing thermal stability after a low-temperature cycle.

### BRIEF DESCRIPTION OF THE FIGURES

FIG. 1A is a graph showing behaviors of the oxygen atom concentration and the fluorine atom concentration on the negative electrode surface based on X-ray photoelectron spectroscopy after a low-temperature cycle followed by storage at 80° C.;

FIG. 1B is a graph showing behaviors of the oxygen atom concentration and the fluorine atom concentration on the negative electrode surface based on X-ray photoelectron spectroscopy after a low-temperature cycle followed by a room-temperature cycle;

FIG. 1C is a graph showing behaviors of the oxygen atom concentration and the fluorine atom concentration on the negative electrode surface based on X-ray photoelectron spectroscopy after a low-temperature cycle;

FIG. 2A is a graph showing the behavior of the battery temperature with respect to the heating time during a heating test of the secondary battery;

FIG. 2B is a graph showing the behavior of the heat generation rate (dT/dt) with respect to the heating temperature during a heating test of the secondary battery;

FIG. 3 is a graph showing the behavior of the calorific value with respect to the heating temperature of a powder mixture of LiPF₆ and Li₂CO₃ and a powder mixture of LiPF₆ and LiF; and

FIG. 4 is a sectional view schematically illustrating the structure of a positive electrode and a negative electrode.

### DETAILED DESCRIPTION

A secondary battery electrode according to an embodiment of the present disclosure will be described below in further detail including with reference to the drawings according to an embodiment. Various elements in the drawings are merely shown schematically and exemplarily for the understanding of the present disclosure, and the appearance, dimensional ratios, and the like may be different from actual ones.

Before specifically describing a secondary battery electrode according to an embodiment of the present disclosure, the basic configuration of the secondary battery will be described. The term “secondary battery” as used herein refers to a battery that can be repeatedly charged and discharged. The “secondary battery” is not unduly restricted by the name of the secondary battery, which can encompass, for example, a “power storage device” and the like. The term “plan view” as used herein means that an object is viewed from the upper side or lower side thereof in the thickness direction based on the direction of stacking electrode materials constituting the secondary battery. In addition, the term “sectional view” as used herein means that an object is viewed from a direction substantially perpendicular to the thickness direction based on the direction of stacking electrode materials constituting the secondary battery. The terms “vertical direction” and “horizontal direction” directly or indirectly used herein respectively correspond to a vertical direction and a horizontal direction in the drawings. Unless otherwise specified, the same symbols or signs shall denote the same members or sites or the same meanings. According to a preferred aspect, it can be understood that a downward direction in a vertical direction (that is, a direction in which gravity acts) corresponds to a “downward direction”, whereas the opposite direction corresponds to an “upward direction”.

Various numerical ranges mentioned herein are intended to include the numerical values themselves of the lower and upper limits. More specifically, when a numerical range such as 1 to 10 is taken as an example, the example can be interpreted as including the lower limit of “1” and also including the upper limit of “10”.

The secondary battery has a structure in which an electrode assembly and an electrolyte are housed and enclosed inside an exterior body. The electrode assembly may include a positive electrode, a negative electrode, and a separator disposed between the positive electrode and the negative electrode. The electrode assembly may be a stacked electrode assembly or a wound (jelly roll type) electrode assembly. The stacked electrode assembly is obtained by stacking a plurality of electrode constituting layers each including a positive electrode, a negative electrode, and a separator. The wound electrode assembly is obtained by winding a plurality of electrode constituting layers each including a positive electrode, a negative electrode, and a separator. In addition, for example, the electrode assembly may have a so-called stack and folding structure, in which the positive electrode, the separator, and the negative electrode are stacked on a long film, and then folded.

A positive electrode 10A includes at least a positive electrode current collector 11A and a positive electrode material layer 12A (see FIG. 4), and the positive electrode material layer 12A is provided on at least one surface of the positive electrode current collector 11A. At a site of the positive electrode current collector 11A where the positive electrode material layer 12A is not provided, that is, at the end of the positive electrode current collector 11A, a positive electrode-side extended tab is positioned. The positive electrode material layer 12A contains therein a positive electrode active material as an electrode active material. A negative electrode 10B includes at least a negative electrode current collector 11B and a negative electrode material layer 12B (see FIG. 4), and the negative electrode material layer 12B is provided on at least one surface of the negative electrode current collector 11B. At a site of the negative electrode current collector 11B where the negative electrode material layer 12B is not provided, that is, at the end of the negative electrode current collector 11B, a negative electrode-side extended tab is positioned. The negative electrode material layer 12B contains therein a negative electrode active material as an electrode active material.

The positive electrode active material included in the positive electrode material layer 12A and the negative electrode active material included in the negative electrode material layer 12B are substances directly involved in the transfer of electrons in the secondary battery and are main substances of the positive and negative electrodes that involve a battery reaction such as charge-discharge. More specifically, ions are brought into the electrolyte due to “the positive electrode active material included in the positive electrode material layer 12A” and “the negative electrode active material included in the negative electrode material layer 12B”, and such ions move between the positive electrode 10A and the negative electrode 10B to transfer electrons, thereby leading to charge-discharge. The positive electrode material layer 12A and the negative electrode material layer 12B are preferably layers capable of occluding and releasing, in particular, lithium ions. More specifically, a secondary battery is preferred in which lithium ions move between the positive electrode 10A and the negative electrode 10B through the electrolyte to charge and discharge the battery. When lithium ions are involved in charge-discharge, the secondary battery corresponds to a so-called “lithium ion battery”.

The positive electrode active material of the positive electrode material layer 12A is made of, for example, a granular material, and a binder is preferably included in the positive electrode material layer 12A for more sufficient contact between grains and shape retention. Furthermore, a conductive auxiliary agent may be included in the positive electrode material layer 12A to facilitate transfer of electrons that promotes the battery reaction. Similarly, the negative electrode active material of the negative electrode material layer 12B is made of, for example, a granular material, a binder is preferably included for more sufficient contact between grains and shape retention, and a conductive auxiliary agent may be included in the negative electrode material layer 12B to facilitate transfer of electrons that promotes the battery reaction. The positive electrode material layer 12A and the negative electrode material layer 12B can also be referred to as “positive electrode mixture layer” and “negative electrode mixture layer”, respectively, because multiple components are contained therein.

The positive electrode active material is preferably a material that contributes to occlusion and release of lithium ions. From such a viewpoint, the positive electrode active material is preferably, for example, a lithium-containing composite oxide. More specifically, the positive electrode active material is preferably a lithium-transition metal composite oxide containing lithium and at least one transition metal selected from the group consisting of cobalt, nickel, manganese, and iron. In other words, such a lithium-transition metal composite oxide is preferably included as a positive electrode active material in the positive electrode material layer 12A of the secondary battery. For example, the positive electrode active material may be lithium cobaltate, lithium nickelate, lithium manganate, lithium iron phosphate, or a material obtained by replacing a part of the transition metal thereof with another metal. Such positive electrode active materials may be included as a single species, or two or more species thereof may be included in combination. In a more preferred aspect, the positive electrode active material contained in the positive electrode material layer 12A is lithium cobaltate.

The binder that can be included in the positive electrode material layer 12A is not particularly limited, and examples of the binder include at least one selected from the group consisting of polyvinylidene fluoride, a vinylidene fluoride-hexafluoropropylene copolymer, a vinylidene fluoride-tetrafluoroethylene copolymer, polytetrafluoroethylene, and the like. The conductive auxiliary agent that can be included in the positive electrode material layer 12A is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives. For example, the binder of the positive electrode material layer 12A may be polyvinylidene fluoride. By way of example only, the conductive auxiliary agent of the positive electrode material layer 12A is carbon black. Furthermore, the binder and conductive auxiliary agent of the positive electrode material layer 12A may be a combination of polyvinylidene fluoride and carbon black.

The negative electrode active material is preferably a material that contributes to occlusion and release of lithium ions. From such a viewpoint, the negative electrode active material is preferably, for example, various carbon materials, oxides, lithium alloys, or the like.

Examples of the various carbon materials for the negative electrode active material include graphite (natural graphite and artificial graphite), soft carbon, hard carbon, and diamond-like carbon. In particular, graphite is preferred in terms of high electron conductivity and excellent adhesiveness to the negative electrode current collector 11B. Examples of the oxides for the negative electrode active material include at least one selected from the group consisting of silicon oxide, tin oxide, indium oxide, zinc oxide, and lithium oxide. The lithium alloy for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La. Such an oxide is preferably amorphous as its structural form. This is because deterioration due to nonuniformity such as crystal grain boundaries or defects is less likely to be caused. By way of example only, the negative electrode active material of the negative electrode material layer 12B may be artificial graphite.

The binder that can be included in the negative electrode material layer 12B is not particularly limited, and examples thereof include at least one selected from the group consisting of a styrene butadiene rubber, a polyacrylic acid, a polyvinylidene fluoride, a polyimide-based resin, and a polyamideimide-based resin. For example, the binder included in the negative electrode material layer 12B may be a styrene-butadiene rubber. The conductive auxiliary agent that can be included in the negative electrode material layer 12B is not particularly limited, and examples thereof include at least one selected from: carbon black such as thermal black, furnace black, channel black, ketjen black, and acetylene black; carbon fibers such as graphite, carbon nanotubes, and vapor grown carbon fibers; metal powders such as copper, nickel, aluminum, and silver; and polyphenylene derivatives. The negative electrode material layer 12B may include therein a component derived from a thickener component (for example, a carboxymethyl cellulose) used in manufacturing the battery.

By way of example only, the negative electrode active material and binder in the negative electrode material layer 12B may be a combination of artificial graphite and styrene-butadiene rubber.

The positive electrode current collector 11A and the negative electrode current collector 11B used for the positive electrode 10A and the negative electrode 10B are members that contribute to collecting and supplying electrons generated in the active materials due to the battery reaction. Such a current collector may be a metal member in a sheet form, and may have a porous or perforated form. For example, the current collector may be a metal foil, a punching metal, a net, an expanded metal, or the like. The positive electrode current collector 11A used for the positive electrode 10A is preferably made of a metal foil containing at least one selected from a group consisting of aluminum, stainless steel, nickel, and the like, and may be, for example, an aluminum foil. In contrast, the negative electrode current collector 11B used for the negative electrode 10B is preferably made of a metal foil containing at least one selected from the group consisting of copper, stainless steel, and nickel, and may be, for example, a copper foil.

A separator 50 is a member provided from the viewpoints such as preventing a short circuit due to contact between the positive and negative electrodes and holding the electrolyte. In other words, the separator 50 can be a member that allows ions to pass while preventing electronic contact between the positive electrode 10A and the negative electrode 10B. Preferably, the separator 50 is a porous or microporous insulating member and has a membrane form due to its small thickness. By way of example only, a microporous membrane made of a polyolefin may be used as the separator. In this respect, the microporous membrane used as the separator 50 may contain, for example, only polyethylene (PE) or only polypropylene (PP) as the polyolefin. Furthermore, the separator 50 may be a laminate composed of a “microporous membrane made of PE” and a “microporous membrane made of PP”. The surface of the separator 50 may be covered with an inorganic particle coating layer and/or an adhesive layer or the like. The surface of the separator may have adhesiveness.

The separator 50 should not be particularly restricted by its name, and may be a solid electrolyte, a gel-like electrolyte, insulating inorganic particles, and the like that have a similar function. Further, from the viewpoint of further improving handling of the electrodes, the separator 50 and the electrodes (positive electrode 10A/negative electrode 10B) are preferably bonded with each other. The separator 50 can be bonded to the electrode by using an adhesive separator as the separator 50, by application and/or thermocompression bonding of an adhesive binder onto the electrode material layer (positive electrode material layer 12A/negative electrode material layer 12B), or the like. Examples of the material of the adhesive binder that provides adhesiveness to the separator 50 or the electrode material layer include polyvinylidene fluoride, a vinylidene fluoride-hexafluoropropylene polymer, and an acrylic resin. The thickness of the adhesive layer by the adhesive binder application or the like may be 0.5 μm or more and 5 μm or less.

When the positive electrode 10A and the negative electrode 10B have a layer capable of occluding and releasing lithium ions, the electrolyte is preferably a “nonaqueous” electrolyte such as an organic electrolyte and/or an organic solvent (that is, the electrolyte is preferably a nonaqueous electrolyte). In the electrolyte, metal ions released from the electrodes (positive electrode 10A/negative electrode 10B) will be present, and the electrolyte will thus assist the movement of the metal ions in the battery reaction.

The non-aqueous electrolyte is an electrolyte including a solvent and a solute. As a specific solvent for the nonaqueous electrolyte, a solvent containing at least a carbonate is preferred. Such a carbonate may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonates include at least one selected from the group consisting of a dimethyl carbonate (DMC), a diethyl carbonate (DEC), an ethyl methyl carbonate (EMC), and a dipropyl carbonate (DPC). By way of example only, a combination of the cyclic carbonates and the chain carbonates is used as the nonaqueous electrolyte, and for example, a mixture of ethylene carbonate and diethyl carbonate may be used. In addition, as a specific solute for the nonaqueous electrolyte, for example, an Li salt such as LiPF₆ or LiBF₄ is preferably used. In addition, as a specific solute for the nonaqueous electrolyte, for example, an Li salt such as LiPF₆ and/or LiBF₄ is preferably used.

As the positive electrode current collecting lead and the negative electrode current collecting lead, it is possible to use any current collecting lead that is used in the field of secondary batteries. Such a current collecting lead may be made of a material that can achieve the movement of electrons, and is made of, for example, a conductive material such as aluminum, nickel, iron, copper, and stainless steel. The positive electrode current collecting lead is preferably made of aluminum, and the negative electrode current collecting lead is preferably made of nickel. The forms of the positive electrode current collecting lead and negative electrode current collecting lead are not particularly limited, and may be, for example, a wire or plate shape.

Any external terminal that is used in the field of secondary batteries can be used as the external terminal. Such an external terminal may be made of a material that can achieve the movement of electrons, and is typically made of a conductive material such as aluminum, nickel, iron, copper, and stainless steel. The external terminal may be electrically and directly connected to a substrate, or may be electrically and indirectly connected to a substrate with another device interposed therebetween. The present disclosure is not limited thereto, and the positive electrode current collecting lead that is connected to each of the plurality of positive electrodes may have the function of a positive electrode external terminal, whereas the negative electrode current collecting lead that is connected to each of the plurality of negative electrodes may have the function of a negative electrode external terminal.

The exterior body may have the form of a conductive hard case or a flexible case (such as a pouch). When the form of the exterior body is a flexible case (such as a pouch), each of the plurality of positive electrodes is connected to the positive electrode external terminal with the positive electrode current collecting lead interposed therebetween. The positive electrode external terminal is fixed to the exterior body with a sealing part, and the sealing part prevents the electrolyte from being leaked. Similarly, each of the plurality of negative electrodes is connected to the negative electrode external terminal with the negative electrode current collecting lead interposed therebetween. The negative electrode external terminal is fixed to the exterior body with a sealing part, and the sealing part prevents the electrolyte from being leaked. The present disclosure is not limited thereto, and the positive electrode current collecting lead that is connected to each of the plurality of positive electrodes may have the function of a positive electrode external terminal, whereas the negative electrode current collecting lead that is connected to each of the plurality of negative electrodes may have the function of a negative electrode external terminal. When the form of the exterior body is a conductive hard case, each of the plurality of positive electrodes is connected to the positive electrode external terminal with the positive electrode current collecting lead interposed therebetween. The positive electrode external terminal is fixed to the exterior body with a sealing part, and the sealing part prevents the electrolyte from being leaked.

The conductive hard case is composed of a main body and a lid. The main body is composed of a bottom constituting the bottom surface of the exterior body and a side surface part. The main body and the lid are sealed after housing the electrode assembly, the electrolyte, the current collecting leads, and the external terminals. The sealing method is not particularly limited, and examples thereof include a laser irradiation method. As a material constituting the main body and the lid, it is possible to use any material that can constitute a hard case type exterior body in the field of secondary batteries. Such a material may be any material that can achieve the movement of electrons, and examples of the material can include conductive materials such as aluminum, nickel, iron, copper, and stainless steel. The dimensions of the main body and lid are determined mainly depending on the dimension of the electrode assembly, and for example, the main body and the lid preferably have such a dimension that the movement (displacement) of the electrode assembly within the exterior body is prevented when the electrode assembly is housed. Preventing the movement of the electrode assembly prevents the electrode assembly from being broken, and improves the safety of the secondary battery.

The flexible case is composed of a soft sheet. The soft sheet only needs to have such softness that the sealing part can be bended, and is preferably a plastic sheet. The plastic sheet is a sheet that has the property of maintaining the deformation by an external force when the external force is applied and then removed, and for example, a so-called laminate film can be used. A flexible pouch formed from a laminate film can be manufactured, for example, by stacking two laminate films on one another and heat-sealing the peripheral edge thereof. As the laminate film, a film obtained by laminating a metal foil and a polymer film is common, and specifically, a three-layer film composed of an outer layer polymer film/a metal foil/an inner layer polymer film is exemplified. The outer layer polymer film is intended to prevent damage to the metal foil due to permeation and contact of moisture and the like, and polymers such as a polyamide and a polyester can be suitably used. The metal foil is intended to prevent permeation of moisture and gas, and a foil of copper, aluminum, stainless steel, or the like can be suitably used. The inner layer polymer film is intended to protect the metal foil from the electrolyte housed inside, and for melt-sealing in heat sealing, and polyolefin or acid-modified polyolefin can be suitably used.

Hereinafter, the features of the present disclosure will be described in further detail according to an embodiment. The inventor of the present application has intensively studied a solution for a secondary battery to keep the thermal stability of the battery, and as a result, has devised the present technology having the following features according to an embodiment.

For example, the secondary battery according to an embodiment of the present disclosure has been subjected to a low-temperature cycle, followed by high-temperature storage or a room-temperature cycle.

The term “low-temperature cycle” as used herein refers to a cycle in which 100 cycles of charge-discharge are performed at a low temperature (−20° C. or higher and 10° C. or lower). The term “room-temperature cycle” as used herein refers to a cycle in which 100 cycles of charge-discharge are performed at room temperature (about 25° C.). The term “high-temperature storage” as used herein refers to storing a battery for a predetermined period at a high temperature (about 50° C. or more and 90° C. or less).

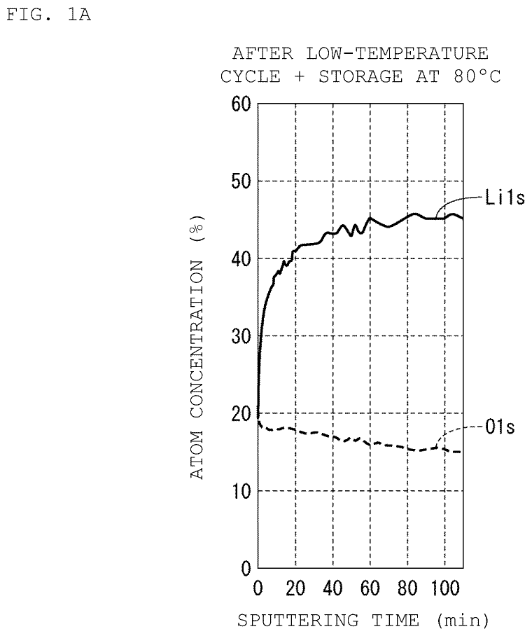

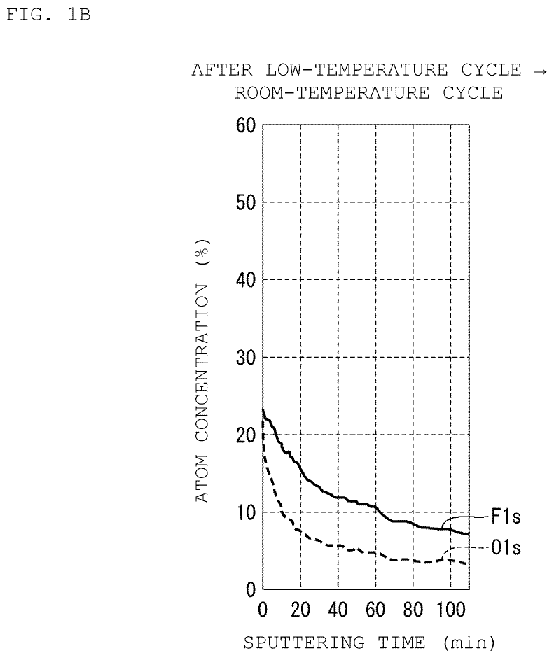

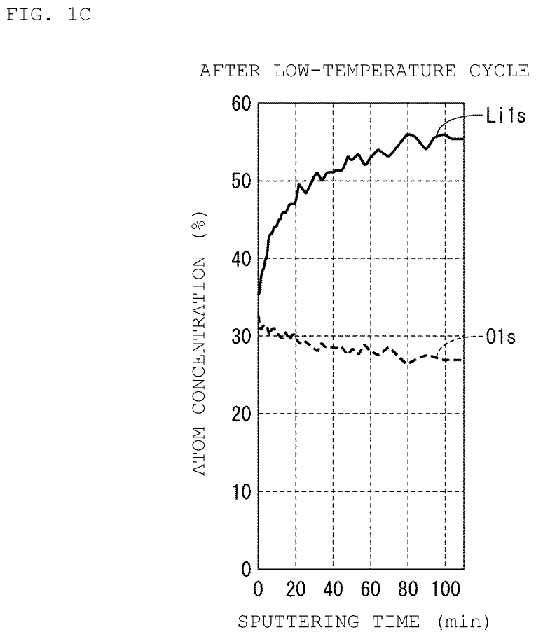

In addition, as compared with FIG. 1C, as shown in FIGS. 1A and 1B, the present disclosure has a technical feature in that, on the surface of the negative electrode of the component, the fluorine atom concentration is higher than the oxygen atom concentration based on X-ray photoelectron spectroscopy after the high-temperature storage or the room-temperature cycle, compared to after the low-temperature cycle.

On the other hand, as shown in FIG. 1C, on the surface of the negative electrode, the fluorine atom concentration is lower than the oxygen atom concentration based on X-ray photoelectron spectroscopy after a low-temperature cycle.

In the present disclosure, an electrolyte containing carbonates (solvent) and LiPF₆ (solute) can be used. In this case, during a low-temperature cycle, lithium ions that have not been accepted into the negative electrode material layer during charging may be bonded with carbonate groups to form Li₂CO₃.

In the present disclosure, the oxygen atoms, which can be present on the surface of the negative electrode, may be derived from at least Li₂CO₃ generated after a low-temperature cycle. In addition, the fluorine atoms, which can be present on the surface of the negative electrode, may be derived from at least LiPF₆.

Here, a compound having a fluorine atom generally has thermal stability. In the present disclosure, on the surface of the negative electrode, the fluorine atom concentration is higher than the oxygen atom concentration after a low-temperature cycle followed by high-temperature storage or a room-temperature cycle.

As for such an increase in the fluorine atom concentration after high-temperature storage or a room-temperature cycle, the property that LiPF₆ as the solute in the electrolyte can be decomposed at room temperature or a high temperature relatively compared to at a low temperature is used.

As described above, in the present disclosure, a fluorine-containing material having thermal stability is present on the surface of the negative electrode in a concentration relatively higher than that of the oxygen atom derived from Li₂CO₃ after high-temperature storage or a room-temperature cycle. That is, since fluorine has a higher concentration than oxygen, a heat-resistant film derived from the fluorine-containing material can be present on the surface of the negative electrode. Although not particularly limited, the fluorine-containing material may include, for example, at least one selected from the group consisting of LiF, POF₃, and CH_{3F}.

The present disclosure has a technical feature also in that, on at least the outermost surface of the negative electrode, the fluorine atom concentration after the high-temperature storage shown in FIG. 1A or the room-temperature cycle shown in FIG. 1B is higher than the fluorine atom concentration after the low-temperature cycle shown in FIG. 1C.

On the outermost surface of the negative electrode, the fluorine atom concentration after high-temperature storage or a room-temperature cycle may have a ratio of 1.5 or more with respect to the fluorine atom concentration after a low-temperature cycle.

There are the following advantages in that such a fluorine-containing material having thermal stability can be present on the surface of the negative electrode in a high concentration after high-temperature storage or a room-temperature cycle.

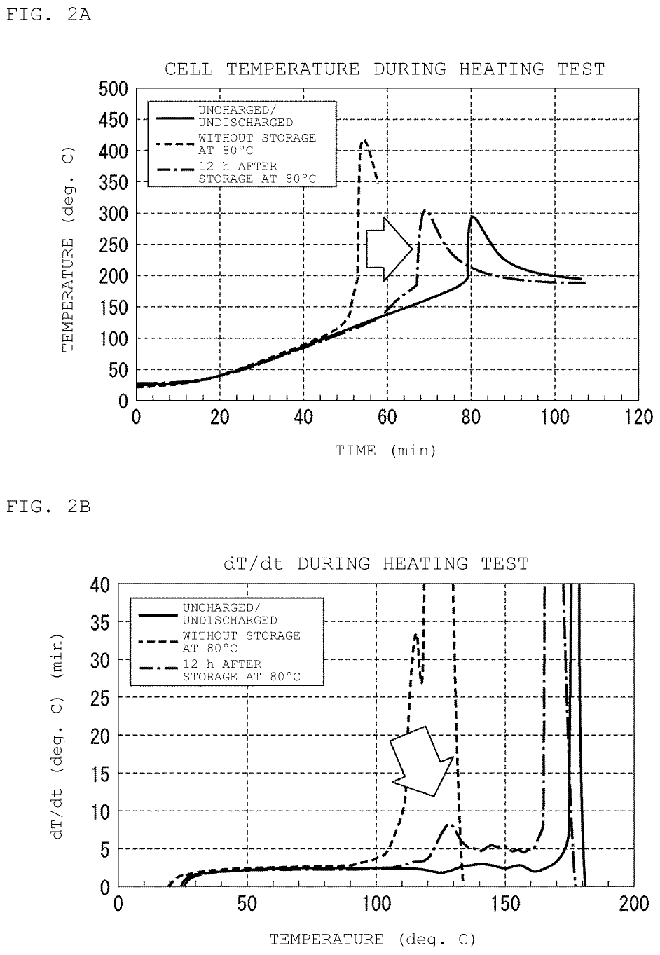

As shown in FIGS. 2A and 2B, it is possible to shift backward the heat generation start time and the heat generation start temperature after a low-temperature cycle followed by high-temperature storage, compared to after a low-temperature cycle (without high-temperature storage).

Furthermore, it is possible to decrease the temperature of the heated cell to an uncharged/undischarged state, and it is possible to decrease the heat generation rate in the temperature zone (about 100° C. or more and 150° C. or less) in an overload test.

The present technology makes it possible to return or recover the thermal stability of the battery, which can be lowered after a low-temperature cycle, to the state before the thermal stability is lowered or the vicinity of the state according to an embodiment. As a result, the thermal stability of a secondary battery once subjected to a low-temperature cycle can be maintained at a predetermined level. That is, the thermal stability of a secondary battery can be suitably secured after a low-temperature cycle.

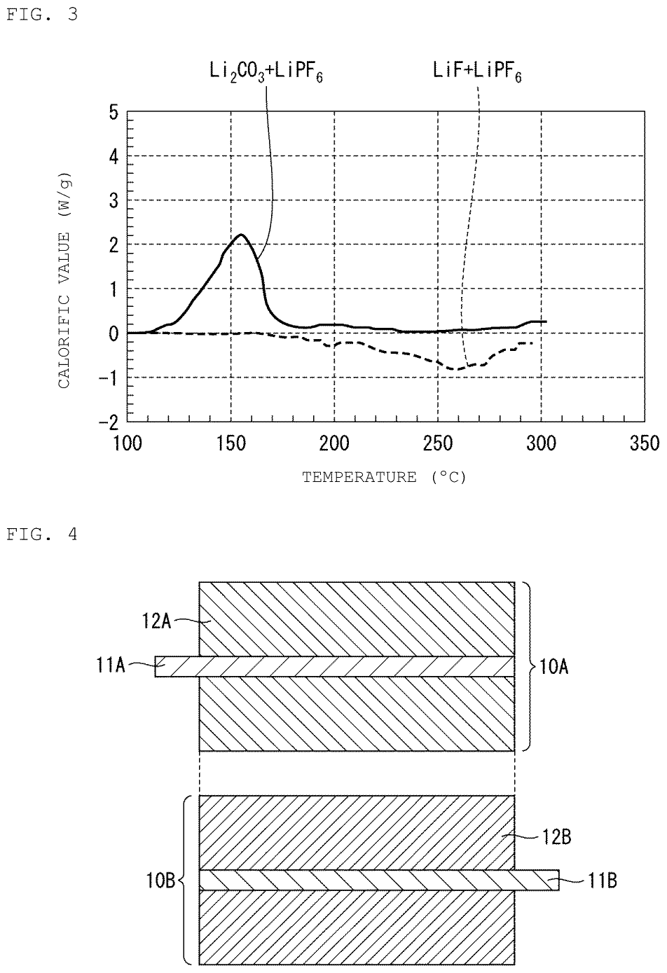

As shown in FIG. 3, when Li₂CO₃ and LiPF₆ coexist in a battery, an exothermic reaction may occur at about 100° C. to about 180° C. Therefore, in the present disclosure, it should be noted that it is necessary to select a temperature zone that is below the temperature range and causes decomposition of LiPF₆.

### EXAMPLES

Hereinafter, Examples 1 to 3 will be described according to an embodiment.

### Example 1

In the Example, a secondary battery having the following components was prepared, and the secondary battery was subjected to a low-temperature cycle, followed by high-temperature storage or a room-temperature cycle.

### Configuration of Secondary Battery

Electrolyte:
Solvent: Ethyl methyl carbonate (EMC) and Solute: LiPF₆ are contained
Negative electrode: Carbon main component
Positive electrode: Lithium cobaltate main component
Separator: PE

### Cycle Conditions

Condition 1: Only low-temperature cycle
100 cycles of charge-discharge (1 C charge/2.5 C discharge/2.5 Vcut) at −5° C.
Condition 2: Low-temperature cycle, followed by high-temperature storage (80° C., 12 h)
High-temperature storage was performed using the battery after the low-temperature cycle.
Condition 3: Low-temperature cycle, followed by room-temperature cycle
100 cycles of charge-discharge (2 C charge/2.5 C discharge/2.5 Vcut) were performed at room temperature after the low-temperature cycle.

### Measurement Based on X-Ray Photoelectron Spectroscopy

After each of the cycle conditions was performed, the negative electrode was taken out from the inside of the cell in a glove box filled with an argon gas, and the negative electrode was washed with dimethyl carbonate. Thereafter, the surface of the negative electrode was analyzed, and the surface was sputtered and then the exposed surface was analyzed under the following conditions based on X-ray photoelectron spectroscopy. The results are shown in FIGS. 1A to 1C.

Various conditions such as X-rays used were as follows.
X-ray source . . . monochromatized Al-Kα (1486.6 eV)
X-ray spot diameter . . . 100 μmφ
Ar⁺ sputtering conditions . . . 1 KV, 1 mm×1 mm, about 7.7 nm/min
Analyzer used in X-ray photoelectron spectroscopy (scanning X-ray photoelectron spectrometer Quantera SXM, manufactured by ULVAC-PHI, INCORPORATED.)

### (Measurement Results)

FIG. 1A shows behaviors of the oxygen atom concentration and the fluorine atom concentration on the negative electrode surface based on X-ray photoelectron spectroscopy after a low-temperature cycle followed by storage at 80° C. FIG. 1B shows behaviors of the oxygen atom concentration and the fluorine atom concentration on the negative electrode surface based on X-ray photoelectron spectroscopy after a low-temperature cycle followed by a room-temperature cycle. FIG. 1C shows behaviors of the oxygen atom concentration and the fluorine atom concentration on the negative electrode surface based on X-ray photoelectron spectroscopy after a low-temperature cycle.

It was understood that the fluorine atom concentration after the high-temperature storage shown in FIG. 1A or the room-temperature cycle shown in FIG. 1B is higher than the fluorine atom concentration after the low-temperature cycle shown in FIG. 1C. Since a compound containing a fluorine atom has thermal stability, it has been found that the fluorine-containing material can be present on the surface of the negative electrode after the high-temperature storage/room-temperature cycle, so that a heat-resistant film derived from the fluorine-containing material can be present on the surface of the negative electrode.

### Example 2

### Heating Test of Secondary Battery

After the cycle conditions 1 and 2, the secondary battery was placed in an oven, and the temperature was measured with a thermocouple. The secondary battery was heated at a temperature rising rate of about 2.5° C./min starting from room temperature. The behavior of the battery temperature with respect to the heating time is shown in FIG. 2A. FIG. 2B shows the behavior of the heat generation rate (dT/dt) with respect to the heating temperature during the heating test.

As shown in FIGS. 2A and 2B, it was understood that it is possible to shift backward the heat generation start time and the heat generation start temperature after a low-temperature cycle followed by high-temperature storage, compared to after a low-temperature cycle (without high-temperature storage). Furthermore, it was understood that it is possible to decrease the temperature of the heated cell to an uncharged/undischarged state, and it is possible to decrease the heat generation rate in the temperature zone (about 100° C. or more and 150° C. or less) in an overload test.

Therefore, it was understood that it is possible to return the thermal stability of the battery that has been lowered after the low-temperature cycle to the state before the thermal stability is lowered or the vicinity of the state.

### Example 3

The behavior of the calorific value when Li₂CO₃ that can be generated in the battery during a low-temperature cycle and LiPF₆ as the solute of the electrolyte coexist was compared with the behavior of the calorific value when Li₂CO₃ is not present and LiPF₆ as the solute of the electrolyte and LiF as a fluorine-containing material coexist.

The behavior of the calorific value was measured under the following conditions using a differential scanning calorimeter (manufactured by Hitachi High-Tech Science Corporation). The results are shown in FIG. 3.
Temperature range: 20 to 380° C.
Heating rate: 10° C./min
Atmosphere: sealing in a dry air environment with a SUS sealed container

As shown in FIG. 3, it was found that, when Li₂CO₃ and LiPF₆ coexist, an exothermic reaction occurs at about 100° C. to about 180° C. Therefore, also from the results of FIG. 3, it is supported that, when a battery in which Li₂CO₃ and LiPF₆ coexist during charge-discharge is used, the battery may have a lower thermal stability.

The present disclosure is described in further detail below according to an embodiment.

<1>

A secondary battery including:
a positive electrode;
a negative electrode; and
an electrolyte, wherein
the secondary battery has been subjected to a low-temperature cycle, followed by high-temperature storage or a room-temperature cycle, and
on a surface of the negative electrode, a fluorine atom concentration is higher than an oxygen atom concentration based on X-ray photoelectron spectroscopy after the high-temperature storage or the room-temperature cycle, compared to after the low-temperature cycle.
   <2>

The secondary battery according to <1>, wherein on at least an outermost surface of the negative electrode, a fluorine atom concentration after the high-temperature storage or the room-temperature cycle is higher than a fluorine atom concentration after the low-temperature cycle.

<3>

The secondary battery according to <2>, wherein on the outermost surface of the negative electrode, a fluorine atom concentration after the high-temperature storage or the room-temperature cycle has a ratio of 1.5 or more with respect to a fluorine atom concentration after the low-temperature cycle.

<4>

The secondary battery according to any one of <1> to <3>, wherein the negative electrode contains a fluorine-containing material on the surface.

<5>

The secondary battery according to <4>, wherein the negative electrode is capable of occluding and releasing lithium ions, and the fluorine-containing material includes at least one selected from the group consisting of LiF, POF₃, and CH₃F.

<6>

The secondary battery according to <4> or <5>, wherein the fluorine-containing material has heat resistance.

<7>

The secondary battery according to any one of <1> to <6>, wherein the electrolyte contains carbonates and LiPF₆.

<8>

The secondary battery according to any one of <1> to <7>, wherein the oxygen atom is derived from at least Li₂CO₃ generated after the low-temperature cycle.

<9>

The secondary battery according to <7>, wherein the fluorine atom is derived from at least LiPF₆.

The secondary battery according to an embodiment of the present disclosure can be used in various fields where power storage is assumed. By way of example only, the secondary battery, in particular, nonaqueous electrolyte secondary battery, according to an embodiment of the present disclosure can be used in electric, information, and communication fields (for example, the fields of mobile devices such as cellular phones, smartphones, lap-top computers, digital cameras, activity meters, arm computers, and electronic papers) in which a mobile device or the like is used, home and small-size industrial applications (for example, the fields of electric tools, golf carts, and domestic, nursing care, or industrial robots), large-size industrial applications (for example, the fields of forklifts, elevators, harbor cranes), transportation system fields (for example, fields such as hybrid vehicles, electric vehicles, buses, trains, power-assisted bicycles, and electric motorcycles), electric power system applications (for example, fields such as various types of electric power generation, load conditioners, smart grids, general household installation-type power storage systems), medical applications (fields of medical device such as earphone hearing aids), pharmaceutical applications (fields such as dosage management systems), IoT fields, space and deep-sea applications (for example, fields such as spacecraft and submersible research vehicles), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A secondary battery comprising:
a positive electrode;
a negative electrode; and
an electrolyte, wherein
the secondary battery is operable to be subject to a low-temperature cycle, followed by a high-temperature storage or a room-temperature cycle, and
on a surface of the negative electrode, a fluorine atom concentration is higher than an oxygen atom concentration based on X-ray photoelectron spectroscopy after the high-temperature storage or the room-temperature cycle, compared to after the low-temperature cycle.

2. The secondary battery according to claim 1, wherein on at least an outermost surface of the negative electrode, a fluorine atom concentration after the high-temperature storage or the room-temperature cycle is higher than a fluorine atom concentration after the low-temperature cycle.

3. The secondary battery according to claim 2, wherein on the outermost surface of the negative electrode, a fluorine atom concentration after the high-temperature storage or the room-temperature cycle has a ratio of 1.5 or more with respect to a fluorine atom concentration after the low-temperature cycle.

4. The secondary battery according to claim 1, wherein the negative electrode contains a fluorine-containing material on the surface.

5. The secondary battery according to claim 4, wherein the negative electrode is capable of occluding and releasing lithium ions, and the fluorine-containing material includes at least one selected from the group consisting of LiF, POF₃, and CH₃F.

6. The secondary battery according to claim 4, wherein the fluorine-containing material has heat resistance.

7. The secondary battery according to claim 1, wherein the electrolyte contains carbonates and LiPF₆.

8. The secondary battery according to claim 1, wherein the oxygen atom is derived from at least Li₂CO₃ generated after the low-temperature cycle.

9. The secondary battery according to claim 7, wherein the fluorine atom is derived from at least LiPF₆.
